(19) United States
(12) Patent Application Publication
(10) Pub. No.: US 2024/0052162 A1
(43) Pub. Date: Feb. 15, 2024

(54) FRICTION REDUCED MATERIALS

(71) Applicant: DSM IP ASSETS B.V., Heerlen (NL)

(72) Inventors: Katarina TOMIC, Echt (NL); Rudy RULKENS, Echt (NL); Michael Hubertus, Helena MEUWISSEN, Echt (NL)

(21) Appl. No.: 17/766,330

(22) PCT Filed: Oct. 12, 2020
(86) PCT No.: PCT/EP2020/078641

§ 371 Date: Apr. 4, 2022

(30) Foreign Application Priority Data
Oct. 10, 2019 (EP) 19202557.5

(51) Int. Cl. C08L 77/06

(52) U.S. Cl. CPC C08L 77/06; C08L 2205/02; C08L 2207/04

(57) ABSTRACT

The invention relates to a thermoplastic composition for use in a sliding element comprising a first polyamide being a polyamide of AA-BB, a second polyamide being a polyamide of AB type and a functional group-modified polyolefin. The invention also relates to a sliding element comprising said thermoplastic composition. The invention further relates to a sliding element comprising said thermoplastic composition for use in a lubricated sliding system, for example in a chain transmission apparatus.

### FIELD OF THE INVENTION

The invention relates to a thermoplastic composition for use in a sliding element. The invention also relates to a sliding element for use in a sliding system, in particular in an oil lubricated sliding system. In particular, the invention relates to a sliding element for use in a chain transmission apparatus comprising a sliding contact section for engagement in sliding contact with a chain, wherein the sliding contact section is mainly made of said thermoplastic composition. The invention also relates to an engine comprising a first sliding element in sliding contact with a second element, wherein at least a sliding contact section is mainly made of said thermoplastic composition. The invention further relates to a chain transmission apparatus, comprising a chain, and a sliding element comprising (i) a sliding contact section engaged in sliding contact with the chain and (ii) a main body reinforcing and supporting the sliding contact section, wherein the sliding contact section is mainly made of said thermoplastic composition.

### BACKGROUND TO THE INVENTION

Nowadays, there is an increasing concern in the automotive industry with the energy consumption, and in particular with the CO 2 emissions, of personal cars and other means of transport. Improvement in fuel economy or fuel consumption is required in internal combustion engines from the viewpoint of environmental protection. To enforce lower CO 2 emissions, governments have installed penalties, or tend to do so, for excessive CO 2 emissions. Therefore, and in particular for reasons of a more sustainable environment, there is a need for more fuel-efficient cars, and more fuel-efficient engines for use in such cars and other transport vehicles.

One of the main causes for automotive vehicles consuming much energy is energy loss due to friction. One important area of friction is in engines comprising a chain driven system, wherein components comprising a sliding element are in sliding contact with the chain during practical use of the engine.

In recent years, there has already been a lot of attention to improve the characteristics of sliding parts such as bearings, rollers, gears and the like from the viewpoint of reducing noise with sliding, lightening weight and providing lubrication to a sliding section, in particular where a plastic sliding material is used in an increasingly severe environment, for example, under higher bearing pressures and higher use temperatures.

Particularly, sliding elements of chain guides and chain tensioners, used in an internal combustion engine of an automotive vehicle are required to have good sliding characteristics, good heat resistance at an elevated temperature such as a temperature in the range from 60° C. to 150° C., good oil resistance, good wear resistance, good fatigue and good impact properties.

Because of a good performance in heat resistance, oil resistance and mechanical strength, often polyamide polymers are used in the sliding elements, at least so for the section of the sliding element engaged in sliding contact with a second element.

However, for applications where the resistance to wear and friction is a key property, these polyamide polymers are not always suitable. In order to improve the frictional resistance of said polyamide polymers during sliding, a solid lubricant has been commonly added, such as polytetrafluoroethylene (PTFE), molybdenum disulfide (MoS₂) or graphite. However, the friction improvement by the addition of said solid lubricants was found to be limited. Furthermore, the addition of said solid lubricants generally reduces the processability of the resulting materials as well as their mechanical and physical properties which is not favourable from the viewpoint of reliability of the parts made thereof. Additionally, when fluorinated additives are used, they have the inconvenience of not being environmentally friendly.

Therefore, despite the improvements that have been made in the development of materials for use in sliding elements, there nevertheless remains a need for further improvements.

Accordingly, the aim of the present invention, amongst other goals, is to provide a thermoplastic composition for use in a sliding element that exhibits desirable properties of sliding and wear characteristics while reducing or solving one or more of the problems of the materials described above.

The aim has been achieved with a thermoplastic composition as described herein below.

### SUMMARY OF THE INVENTION

The present invention relates to a thermoplastic composition for use in a sliding element comprising 60 to 95 wt. % of a first polyamide (a) being a polyamide of AA-BB type, 0.5 to 10 wt. % of a second polyamide (b) being a polyamide of AB type, and 0.5 to 35 wt. % of a functional group-modified polyolefin (c), wherein wt. % are relative to the total weight of the thermoplastic composition.

The invention further relates to a sliding element comprising said thermoplastic composition.

The invention further relates to a sliding element, such as comprised by a chain guide or a chain tensioner, for use in a lubricated sliding system.

The invention further relates to a sliding element for use in a chain transmission apparatus, comprising a sliding contact section for engagement in sliding contact with a chain, wherein the sliding contact section is mainly made of said thermoplastic composition.

The invention further relates to an engine comprising a first sliding element in sliding contact with a second element, wherein at least a sliding contact section is mainly made of said thermoplastic composition.

The invention further relates to a chain transmission apparatus, comprising a chain, and a sliding element comprising (i) a sliding contact section engaged in sliding contact with the chain and (ii) a main body reinforcing and supporting the sliding contact section, wherein the sliding contact section is mainly made of said thermoplastic composition.

### DETAILED DESCRIPTION OF THE INVENTION

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element.

In the context of the present invention, it was surprisingly found that a thermoplastic composition comprising two types of polyamides and a modified polyolefin exhibited very good processability and conferred excellent sliding characteristics combined with advantageous wear resistance and mechanical properties (such as impact resistance, stiffness and ductility) to a moulded part made therefrom. That is to say, said thermoplastic composition confers an increased performance to a sliding element when said sliding element comprises said thermoplastic composition.

It is therefore an object of the present invention to provide a new thermoplastic composition for use in a sliding element.

It is further an object of the invention to provide a sliding element comprising said thermoplastic composition.

It is further an object of the invention to provide a sliding element comprising said thermoplastic composition, such as comprised by a chain guide or a chain tensioner, for use in a lubricated sliding system.

It is further an object of the invention to provide a sliding element for use in a chain transmission apparatus, comprising a sliding contact section for engagement in sliding contact with a chain, wherein the sliding contact section is mainly made of said thermoplastic composition.

It is further an object of the invention to provide an engine comprising a first sliding element in sliding contact with a second element, wherein at least a sliding contact section is mainly made of said thermoplastic composition.

It is further an object of the invention to provide a chain transmission apparatus, comprising a chain, and a sliding element comprising (i) a sliding contact section engaged in sliding contact with the chain and (ii) a main body reinforcing and supporting the sliding contact section, wherein the sliding contact section is mainly made of said thermoplastic composition.

The thermoplastic composition for use in a sliding element according to the present invention comprises 60 to 95 wt. % of a first polyamide (a) being a polyamide of AA-BB type, 0.5 to 10 wt. % of a second polyamide (b) being a polyamide of AB type, and 0.5 to 35 wt. % of a functional group-modified polyolefin (c), wherein wt. % are relative to the total weight of the thermoplastic composition.

In the context of the invention, a “sliding element” is to be understood to comprise a “sliding contact section” which is the section of the sliding element being engaged in sliding and/or rolling contact with (or intended for engagement in sliding and/or rolling contact with) with the sliding contact section of another sliding element, and for which reason the sliding contact section has to have low friction characteristics.

Herein, a “polyamide” is a polymer with monomeric building blocks linked together by amide functionalities (Kunststoff Handbuch; G. W. Becker, D. Braun, eds; 1998; vol 3/4; Polyamide). The polyamide has typically a viscosity number (as measured according to ISO 307) of 50 to 250 g/ml. The term “polyamide” is taken in the broad meaning and includes polyamides, copolyamides or mixtures thereof.

Herein, a “polyamide of AA-BB type” or “AA-BB polyamide” or “AA-BB type polyamide” is primarily based on diamines (AA-type monomers) and dicarboxylic acids (BB-type monomers). Said polyamide may comprise additional bifunctional units (e.g. a bifunctional unit derived from an α,ω-amino acid or its lactam derivative thereof). However, the content of such additional bifunctional units is generally less than 20 mole %, wherein mole % is relative to the total molar amount of the bifunctional units in said polyamide. Preferably, the content of such additional bifunctional units is generally less than 10 mole %, wherein mole % is relative to the total molar amount of the bifunctional units in said polyamide.

Herein, a “polyamide of AB type” or “AB polyamide” or “AB type polyamide” is primarily based on AB repeat units derived from α,ω-amino acids and their lactam derivatives thereof (AB monomers). Said polyamide may comprise additional bifunctional units derived from other components. However, the content of such additional bifunctional units is generally less than 20 mole %, wherein mole % is relative to the total molar amount of the bifunctional units in said polyamide. Preferably, the content of such additional bifunctional units is generally less than 10 mole %, wherein mole % is relative to the total molar amount of the bifunctional units in said polyamide.

Herein a “polyolefin” is a polymer produced from an olefin (i.e. an alkene) as a monomer. The term “polyolefin” is taken in the broad meaning and includes polymers and copolymers of one or more olefins and mixtures thereof. Examples of olefins are ethylene, propylene, butenes and pentenes.

Herein, a “functional group-modified polyolefin” (also referred to as a “functional group-grafted polyolefin” or a “modified polyolefin” or a “grafted polyolefin”) is to be understood as a polyolefin modified (grafted) with a functional group capable of reacting with terminal group and/or main chain amide group of a polyamide (i.e. a reactive chemical group). In the context of the present invention, the term “unmodified polyolefin” (also referred to as a “polyolefin”) is to be understood as a polyolefin which has not been modified (grafted) with such a functional group.

Herein, all ranges indicated as “x to y” are to be understood from x to y and include the x and y values.

Herein, all ranges indicated as “above x”, “more than x”, “below x”, or “less than x” are to be understood to not include the x value.

The thermoplastic composition according to the present invention comprises a first polyamide (a) being a polyamide of AA-BB type and a second polyamide (b) being a polyamide of AB type.

In one embodiment of the present invention, the first polyamide (a) of AA-BB type is a semi-crystalline polyamide having a melting temperature (Tm-1) and the second polyamide (b) of AB type is a semi-crystalline polyamide having a melting temperature (Tm-2), wherein Tm-2 is at least 20° C. lower than Tm-1. More preferably, Tm-2 is at least 30° C., more preferably at least 40° C., even more preferably at least 50° C., still more preferably at least 60° C., and most preferably at least 70° C. lower than Tm-1.

In a preferred embodiment of the present invention, the first polyamide (a) of AA-BB type has a Tm-1 of at least 230° C., preferably at least 240° C., more preferably at least 250° C., more preferably at least 260° C., also more preferably at least 270° C., even more preferably at least 280° C., even more preferably at least 290° C. and most preferably at least 300° C.

With the melting temperature is herein understood to be the temperature measured by the DSC method according to ISO-11357-1/3, 2011, on pre-dried samples in a N₂ atmosphere with heating and cooling rate of 10° C./min. Herein, Tm is calculated from the peak value of the highest melting peak in the second heating cycle.

In another embodiment of the present invention, the first polyamide (a) of AA-BB type includes aliphatic polyamides and semi-aromatic polyamides, as well as copolyamides and mixtures thereof.

In particular, suitable aliphatic polyamides of the first polyamide (a) may be PA 28, PA 210, PA 212, PA 214, PA 216, PA 218, PA 46, PA 48, PA 410, PA 412, PA 414, PA 56, PA 62, PA 66, PA 68, PA 6CHDA, PA 82, PA 86, PA 102, PA 106, PA 122, PA 126, PA 142, PA 162, PA 182, PA 10CHDA, copolyamides and mixtures thereof. Suitable aliphatic copolyamides of the first polyamide (a) may be PA 46/66, PA6/66, PA66/11, PA66/12, PA6/610, PA66/610, PA46/6, PA6/66/610, copolyamides obtained from 1,4-cyclohexanedicarboxylic acid (CHDA) and 2,2,4- and 2,4,4-trimethylhexamethylenediamine, copolyamides obtained from any dicarboxylic acid and isophorondiamine, 4,4-diaminodicyclohexylmethane and/or 3,5-dimethyl-4,4-diamino-cicyclohexylmethane, copolyamides and mixtures thereof.

Also, in particular, suitable semi-aromatic polyamides of the first polyamide (a) may be PA4T, PA5T, PA6T, PA9T, PA10T, PA 12T, PA MXD6, PA PXD6 (wherein PXD6 is p-xylylenediamine), PA4T/6T, PA 10T/106, PA10T/5T, PA10T/9T, PA10T/1012, PA10T/NDT/INDT, PA 10T/11, PA 10T/MACMT, PA 10T/MACMT, PA 10T/PACMT, PA6T/4T, PA 6T/4T/66, PA 6T/4T/DT, PA 6T/4T/DT/DI, PA 6T/4T/6I, PA 6T/10T, PA 6T/6I, PA6T/NDT/INDT, PA 6T/MACMT, PA 6T/4T/MACMT, PA 6T/PACMT, PA 6T/4T/PACMT, PA 6T/MXDT, PA 6T/1,3-BACT (wherein 1,3-BAC is hydrogenated MXD), PA6T/DT-copolyamide with D=2-methylpentamethylenediamine, PA4T/6, PA4T/66, PA4T/46, PA4T/410, PA6I, PA6I/66, PA6T, PA6T/6, PA6T/66, PA6I/6T, PA66/6T/6I, PA6T/2-MPMDT (wherein 2-MPMD is 2-methylpentamethylene diamine), PA9T, PA9T/2-MOMDT (wherein 2-MOMD is 2-methyl-1,8-octamethylenediamine), copolyamides obtained from terephthalic acid, ND and/or IND, copolyamides obtained from caprolactam, isophthalic acid and/or terephthalic acid and PACM, copolyamides obtained from caprolactam, isophthalic acid and/or terephthalic acid and isophoronediamine, copolyamides obtained from isophthalic acid and/or terephthalic acid and/or other aromatic or aliphatic dicarboxylic acids, optionally alkyl-substituted hexamethylenediamine and alkyl-substituted PACM, copolyamides of the aforementioned polyamides and mixtures thereof.

Preferably, the first polyamide (a) of AA-BB type is selected from PA66, PA46, PA410, PA412, PA5T, PA6T, PA6T, PA6T/6I, PA6T/66, PA6T/6, PA 6T/4T, PA6/66, PA66/6T/6I, PA6T/DT-copolyamide, PA9T, PA9T/2-MOMDT-copolyamide, PA 10T, PA 10T/106, PA 10T/6T, PA46/6, a copolyamide or a mixture thereof.

More preferably, the first polyamide (a) of AA-BB type is selected from PA 6T/4T, PA 6T/4T/66, PA 6T/4T/DT, PA 6T/4T/DT/DI, PA 6T/4T/6I, PA 6T/6I, PA 66, PA 6T/66, PA 6T/66/6I, PA 6T/DT, PA 9T, PA 9T/2-MOMDT, PA 10T, PA 10T/106, PA 10T/6T, PA46, a copolyamide or a mixture thereof.

Even more preferably, the first polyamide (a) of AA-BB type is selected from PA 6T/4T, PA 6T/4T/66, PA 6T/4T/DT, PA 6T/4T/DT/DI, PA 6T/4T/6I, PA 6T/6I, PA 66, PA 6T/66, PA 6T/66/6I, PA 6T/DT, PA 9T, PA 9T/2-MOMDT, PA46, a copolyamide or a mixture thereof.

Even more preferably, the first polyamide (a) of AA-BB type is selected from PA 6T/4T, PA 6T/4T/66, PA 6T/4T/DT, PA 6T/4T/DT/DI, PA 6T/4T/6I, PA 6T/6I, PA 6T/66, PA 6T/66/6I, PA 6T/DT, PA 9T, PA 9T/2-MOMDT, PA46, a copolyamide or a mixture thereof.

In another embodiment of the invention, the second polyamide (b) of AB type includes aliphatic polyamides, as well as copolyamides and mixtures thereof.

In particular, the second polyamides (b) of AB type is selected from PA 6, PA 7, PA 8, PA 9, PA 10, PA 11, PA 12, a copolyamide or a mixture thereof.

More in particular, the second polyamides (b) of AB type is selected from PA 6, PA 9, PA 10, PA 11, PA 12, a copolyamide or a mixture thereof.

Even more in particular, the second polyamides (b) of AB type is selected from PA 6, PA 11, PA 12, a copolyamide or a mixture thereof.

Preferably, the second polyamide (b) of AB type comprises PA 6 or a copolyamide thereof. More preferably, the second polyamide (b) comprises at least 80 mole % PA 6, in particular at least 85 mole % PA 6, more in particular at least 90 mole %, even more in particular at least 95 mole % PA 6, and most in particular at least 98 mole % PA 6. Most preferably, the second polyamide (b) of AB type is PA 6.

In yet another embodiment of the invention, suitable polyamide combinations of the first polyamide (a) of AA-BB type and the second polyamide (b) of AB type are for examples combinations wherein the first polyamide (a) is selected from PA 46, PA 410, PA 5T, PA 6T/4T, PA 6T/4T/DT/DI, PA 66, PA 6T, PA 9T, PA 10T, a copolyamide or a mixture thereof and wherein the second polyamide (b) is selected from PA 6, PA 11, PA 12, a copolyamide or a mixture thereof. Preferred polyamide combinations of the first and second polyamides are combinations wherein the first polyamide (a) is selected from PA 46, PA 66, PA 46/6, PA 6T/4T, PA 6T/4T/DT/DI, a copolyamide or a mixture thereof and wherein the second polyamide (b) is selected from PA 6, PA 11, PA 12, a copolyamide or a mixture thereof. More preferred polyamide combinations of the first and second polyamides are combinations wherein the first polyamide (a) is selected from PA 46, PA 46/6, PA 6T/4T, PA 6T/4T/DT/DI, a copolyamide or a mixture thereof and wherein the second polyamide (b) is selected from PA 6, PA 11, PA 12, a copolyamide or a mixture thereof. Even more preferred polyamide combinations of the first and second polyamides are combinations wherein the first polyamide (a) is selected from PA 46, PA 46/6, PA 6T/4T, PA 6T/4T/DT/DI, a copolyamide or a mixture thereof and wherein the second polyamide (b) comprises or consists of PA 6.

With reference to the above polyamides, the nomenclature is adhered to as used in EN ISO 1874-1: 2000; e.g. PA 6T denotes a homopolymer with building blocks 1,6-hexanediamine and terephthalic acid, PA 66/6T denotes a copolymer made from 1,6-hexanediamine, adipic acid and terephthalic acid and a blend of PA 66 and PA 6T is described as PA 66/PA 6T.

Advantageously, the first polyamide (a) of AA-BB type has a concentration of amino (NH 2) end-groups in the range of 10 to 80 meq/kg, more preferably in the range of 15 to 75 meq/kg, even more preferably in the range of 15 to 70 meq/kg, and most preferably in the range of 20 to 60 meq/kg, as measured by titration of a methanol solution of the polyamide with 0.03 N hydrochloric acid.

Also, advantageously, the second polyamide (b) of AB type has a concentration of amino (NH 2) end-groups in the range 10 to 100 meq/kg, more preferably in the range of 15-95 meq/kg, even more preferably in the range of 15 to 90 meq/kg, and most preferably in the range of 20 to 80 meq/kg, as measured by titration of a methanol solution of the polyamide with 0.03 N hydrochloric acid.

In the context of the present invention, the first polyamide (a) of AA-BB type is present in an amount of 60 to 95 wt. %, wherein wt. % is relative to the total weight of the thermoplastic composition. Preferably, the first polyamide (a) is present in an amount of 65 to 95 wt. %, more preferably 70 to 95 wt. %, wherein wt. % is relative to the total weight of the thermoplastic composition. More preferably, the first polyamide (a) is present in an amount of less than 95 wt. %. In particular, the first polyamide (a) is present in amount of 60 to 90 wt. %, preferably 65 to 90 wt. %, even more preferably 70 to 90 wt. %, wherein wt. % is relative to the total weight of the thermoplastic composition. More in particular, the first polyamide (a) is present in amount of 60 to 85 wt. %, preferably 65 to 85 wt. %, even more preferably 70 to 85 wt. %, wherein wt. % is relative to the total weight of the thermoplastic composition.

In the context of the present invention, the second polyamide (b) of AB type is present in a limited amount such that the overall performance of the thermoplastic composition is not affected or only to a small extent. A limited amount of the second polyamide (b) of AB type is defined as an amount in the range of 0.5 to 10 wt. % or any sub-range as defined thereafter, wherein wt. % is relative to the total weight of the thermoplastic composition. The second polyamide (b) is preferably present in an amount of 1 wt. % or above, more preferably in an amount of 2 wt. % or above, even more preferably in an amount of 3 wt. % or above, and most preferably in an amount of 4 wt. % or above, wherein wt. % is relative to the total weight of the thermoplastic composition. The second polyamide (b) is preferably present in an amount of 10 wt. % or below, more preferably in an amount of 8 wt. % or below, even more preferably in an amount of 6 wt. % or below, most preferably in an amount of 5 wt. % or below, and even most preferably in an amount of less than 5 wt. %, wherein wt. % is relative to the total weight of the thermoplastic composition. That is, the second polyamide (b) is present in an amount of 4.99 wt. % or below, preferably in an amount of 4.95 wt. % or below, more preferably in an amount of 4.9 wt. % or below, and most preferably in an amount of 4.5 wt. % or below, wherein wt. % is relative to the total weight of the thermoplastic composition.

In particular, the second polyamide (b) is present in an amount of 0.5 wt. % to 10 wt %, preferably in an amount of 0.5 wt. % to 8 wt. %, more preferably in an amount of 0.5 wt. % to 6 wt. %, even more preferably in an amount of 0.5 wt. % to 5 wt. %, wherein wt. % is relative to the total weight of the thermoplastic composition. Also, in particular, the second polyamide (b) is present in an amount of 0.5 to 4.99 wt. %, preferably in an amount of 0.5 to 4.95 wt. %, more preferably in an amount of 0.5 to 4.9 wt. %, and most preferably in an amount of 0.5 to 4.5 wt. %, wherein wt. % is relative to the total weight of the thermoplastic composition.

More in particular, the second polyamide (b) is present in an amount of 1 wt. % to 10 wt %, preferably in an amount of 1 wt. % to 8 wt. %, more preferably in an amount of 1 wt. % to 6 wt. %, even more preferably in an amount of 1 wt. % to 5 wt. %, wherein wt. % is relative to the total weight of the thermoplastic composition. Also, in particular, the second polyamide (b) is present in an amount of 1 to 4.99 wt. %, preferably in an amount of 1 to 4.95 wt. %, more preferably in an amount of 1 to 4.9 wt. %, and most preferably in an amount of 1 to 4.5 wt. %, wherein wt. % is relative to the total weight of the thermoplastic composition.

Even more in particular, the second polyamide (b) is present in an amount of 2 wt. % to 10 wt %, preferably in an amount of 2 wt. % to 8 wt. %, more preferably in an amount of 2 wt. % to 6 wt. %, even more preferably in an amount of 2 wt. % to 5 wt. %, wherein wt. % is relative to the total weight of the thermoplastic composition. Also, in particular, the second polyamide (b) is present in an amount of 2 to 4.99 wt. %, preferably in an amount of 2 to 4.95 wt. %, more preferably in an amount of 2 to 4.9 wt. %, and most preferably in an amount of 2 to 4.5 wt. %, wherein wt. % is relative to the total weight of the thermoplastic composition.

Even more in particular, the second polyamide (b) is present in an amount of 4 wt. % to 10 wt %, preferably in an amount of 4 wt. % to 8 wt. %, more preferably in an amount of 4 wt. % to 6 wt. %, even more preferably in an amount of 4 wt. % to 5 wt. %, wherein wt. % is relative to the total weight of the thermoplastic composition. Also, in particular, the second polyamide (b) is present in an amount of 4 to 4.99 wt. %, preferably in an amount of 4 to 4.95 wt. %, more preferably in an amount of 4 to 4.9 wt. %, and most preferably in an amount of 4 to 4.5 wt. %, wherein wt. % is relative to the total weight of the thermoplastic composition.

The thermoplastic composition according to the present invention further comprises a functional group-modified polyolefin, that is to say a polyolefin modified (grafted) with a functional group capable of reacting with terminal group and/or main chain amide group of a polyamide.

Suitable polyolefin polymers in the thermoplastic composition according to the invention are homo- and copolymers of one or more olefin polymers that can be grafted with a functional group.

Examples of suitable polyolefin polymers are ethylene polymers, propylene polymers, and styrene-butadiene-styrene block copolymers or the hydrogenated form thereof.

Examples of suitable ethylene polymers are all thermoplastic homopolymers of ethylene and copolymers of ethylene with as comonomer one or more α-olefins with 3-10 C atoms, in particular propylene, iso-butene, 1-butene, 1-hexene, 4-methyl-1-pentene and 1-octene which can be manufactured with the known catalysts such as for example Ziegler-Natta, Phillips and metallocene catalysts. The quantity of comonomer lies as a rule in the range of 0 to 50 wt. %, and preferably in the range of 5 to 35 wt. %. Such ethylene polymers are for instance known as high-density polyethylene (HDPE), low-density polyethylene (LDPE), linear low-density polyethylene (LLDPE) and linear very low-density polyethylene (VL(L)DPE). Suitable polyethylene polymers have a density in the range of 800 to 970 kg/m³.

Examples of suitable propylene polymers are homopolymers of propylene and copolymers of propylene with ethylene, in which the portion of ethylene amounts to at most 30 wt. % and preferably at most 25 wt. %.

Suitable functional groups are those that can be grafted on at least one of the above-mentioned suitable polyolefin polymers. Examples of said functional groups are carboxylic acid group, carboxylic acid metal base, acid anhydride group, ester group, epoxy group, oxazoline group, amino group, isocyanate group and a mixture thereof. Preferably, said functional group is selected from an epoxy group, an acid anhydride group and mixture thereof. More preferably, said functional group is an acid anhydride group.

Accordingly, the functional group-modified polyolefin is advantageously selected from the group consisting of a dicarboxylic acid anhydride-modified polyolefin, an epoxy-modified polyolefin and a mixture thereof. Preferably, the functional group-modified polyolefin is a maleic anhydride (MAH)-grafted polyolefin. More preferably, the functional group-modified polyolefin is selected from a maleic anhydride-modified polyethylene, a maleic anhydride-modified polypropylene, a maleic anhydride-modified propylene copolymer, and a maleic anhydride-modified ethylene copolymer.

Advantageously, the functional group-modified polyolefin has a density in the range of 800 to 970 kg/m³, preferably in the range 820 to 970 kg/m³, preferably in the range 850 to 970 kg/m³, preferably in the range of 850 to 950 kg/m³, more preferably in the range of 860 to 950 kg/m³, more preferably in the range of 860 to 920 kg/m³, and even more preferably in the range of 860 to 900 kg/m³, as measured according to the ISO norm ISO 1183.

Advantageously, the Melt Flow Rate (MFR; 230° C., 2.16 kg load) of the functional group-modified polyolefin lies in the range of 0.5 to 25 g/10 min, preferably in the range of 0.5 to 15 g/10 min, more preferably in the range of 0.5 to 10 g/10 min, more preferably in the range of 0.5 to 8 g/10 min, even more preferably in the range of 1 to 8 g/10 min, most preferably in the range of 1.5 to 7.5 g/10 min, as measured according the ASTM norm D1238.

Also, advantageously, the content of functional group in the modified polyolefin lies in the range of 0.05 to 3.0 wt. %, preferably in the range of 0.05 to 2.5 wt. %, preferably in the range of 0.1 to 2.5 wt. %, preferably in the range of 0.2 to 2.5 wt. %, more preferably in the range of 0.3 to 2.5 wt. %, more preferably in the range of 0.3 to 2.0 wt. %, even more preferably in the range of 0.4 to 2.0 wt. %, even more preferably in the range of 0.4 to 1.5 wt. %, even more preferably in the range of 0.4 to 1.2 wt. %, most preferably in the range of 0.5 to 1.0 wt. %, wherein wt. % is relative to the total weight of the functional group-modified polyolefin.

In particular, the content of maleic anhydride (MAH) in the modified polyolefin lies in the range of 0.05 to 3.0 wt. %, preferably in the range of 0.05 to 2.5 wt. %, preferably in the range of 0.1 to 2.5 wt. %, preferably in the range of 0.2 to 2.5 wt. %, more preferably in the range of 0.3 to 2.5 wt. %, more preferably in the range of 0.3 to 2.0 wt. %, even more preferably in the range of 0.4 to 2.0 wt. %, even more preferably in the range of 0.4 to 1.5 wt. %, even more preferably in the range of 0.4 to 1.2 wt. %, most preferably in the range of 0.5 to 1.0 wt. %, wherein wt. % is relative to the total weight of the functional group-modified polyolefin. The MAH content is measured by infra-red spectroscopy as described in the “test methods” section of the Examples.

Said modified polyolefins can be prepared according to methods known per se for this purpose, for example as described in U.S. Pat. Nos. 3,236,917 and 5,194,509 and 4,950,541. Additionally, said modified polyolefins are also commercially available under various tradenames, such as Fusabond®, Exxelor™, Tafmer® and Paraloid™.

In the thermoplastic composition of the present invention, the functional group-modified polyolefin (c) is advantageously present in an amount of 0.5 to 35 wt. %, preferably of 1 to 35 wt. %, more preferably 5 to 35 wt. %, even more preferably 8 to 35 wt. % and most preferably 10 to 35 wt. %, wherein wt. % is relative to the total weight of the thermoplastic composition. Also, advantageously, the functional group-modified polyolefin (c) is present in an amount of 0.5 to 30 wt. %, preferably of 1 to 30 wt. %, more preferably 5 to 30 wt. %, even more preferably 8 to 30 wt. % and most preferably 10 to 30 wt. %, wherein wt. % is relative to the total weight of the thermoplastic composition. Also, advantageously, the functional group-modified polyolefin (c) is present in an amount of 0.5 to 25 wt. %, preferably of 1 to 25 wt. %, more preferably 5 to 25 wt. %, even more preferably 8 to 25 wt. % and most preferably 10 to 25 wt. %, wherein wt. % is relative to the total weight of the thermoplastic composition. Also, advantageously, the functional group-modified polyolefin (c) is present in an amount of 0.5 to 20 wt. %, preferably of 1 to 20 wt. %, more preferably 5 to 20 wt. %, even more preferably 8 to 20 wt. % and most preferably 10 to 20 wt. %, wherein wt. % is relative to the total weight of the thermoplastic composition. Also, advantageously, the functional group-modified polyolefin (c) is present in an amount of 0.5 to 19 wt. %, preferably of 1 to 19 wt. %, more preferably 5 to 19 wt. %, even more preferably 8 to 19 wt. % and most preferably 10 to 19 wt. %, wherein wt. % is relative to the total weight of the thermoplastic composition.

In a further embodiment of the invention, the thermoplastic composition of the present invention may comprise at least one other component (d). For example, the other component may be selected from or a mixture of:
a polymer other than polyamide (a), polyamide (b) and functional group-modified polyolefin (c),
an inorganic nucleating agent,
an inorganic filler and/or a fibrous reinforcing agent, and
an auxiliary additive.

For the polymer other than polyamide (a), polyamide (b) and functional group-modified polyolefin (c), in principle, any thermoplastic or thermoset polymer may be used as long as these polymers are used in a limited amount such that the overall performance of the thermoplastic composition is not affected or only to a small extent. For example, said polymer may be an unmodified polyolefin. Suitably, the amount is limited to a range of, for example, 0.01 to 20 wt. %, wherein wt. % is relative to the total weight of the thermoplastic composition. Practically, if used at all, the amount is limited to a range of 0.01 to 15 wt. %, or even 0.01 to 10 wt. %, wherein wt. % is relative to the total weight of the thermoplastic composition.

A suitable inorganic nucleating agent may be selected from micro-talc and carbon black. The inorganic agent may be present in an amount which approximately is in the range of 0.01 to 5 wt. %, wherein wt. % is relative to the total weight of the thermoplastic composition.

For the inorganic filler and/or fibrous reinforcing agent, any inorganic material that improves the mechanical properties, such as tensile strength and modulus, may be used. Since many of these materials can have a negative effect on the wear properties of the plastic material, the amount thereof, if used at all, should preferably be kept limited. Examples of fibrous reinforcing agents are glass fibers and carbon fibers. Of these carbon fibers are preferred, as these might sometimes even improve the low friction properties.

If present, suitably the total amount of the inorganic filler and/or fibrous reinforcing agent in the composition is in a range of, for example, 0.01 to 20 wt.

%, wherein wt. % is relative to the total weight of the thermoplastic composition. Preferably, the amount is in the range of 0.01 to 15 wt. %, or more in particular 0.01 to 10 wt. %, wherein wt. % is relative to the total weight of the thermoplastic composition.

In a preferred embodiment, the inorganic filler is a granular or particulate solid inorganic lubricant. The solid inorganic lubricant may comprise a material chosen from the group consisting of molybdenum disulfide, natural or synthetic graphite, boron nitride and silane nitride, and any mixtures thereof. With the term natural or synthetic graphite herein understood that the graphite is different from the graphite platelets used as the main solid lubricant in the present invention.

If present, the solid inorganic lubricant particles can be present in an amount in the range of, for example, 0.01 to 10 wt. %, although higher amounts may also be used. Preferably, if such solid lubricants are used at all, the amount is limited to a range of 0.01 to 7.5 wt. %, or even 0.01 to 5 wt. %, wherein wt. % is relative to the total weight of the thermoplastic composition.

The composition may also comprise an auxiliary additive. Examples of auxiliary additives comprises mold release agents, pigments and stabilizers such as heat stabilizers, oxidative stabilizers, UV light stabilizers and chemical stabilizers. If present, such auxiliary additives are typically used in limited amounts, for example in the range of 0.01 to 10 wt. %. Suitably, if used at all, the amount is limited to a range of 0.01 to 7.5 wt. %, 0.01 to 5 wt. %, or even 0.01 to 2.5 wt. %, wherein wt. % is relative to the total weight of the thermoplastic composition.

In the context of the present invention, the other component (d) is preferably not polytetrafluoroethylene, molybdenum disulfide, or graphite. Accordingly, in one embodiment, the thermoplastic composition for use in a sliding element comprises:
60 to 95 wt. % of a first polyamide (a) being a polyamide of AA-BB type,
0.5 to 10 wt. %, preferably 1 to 10 wt. %, more preferably 2 to 10 wt. %, even more preferably 2 to 8 wt. %, even more preferably 2 to 6 wt. %, even more preferably 4 to 6 wt. %, even more preferably 4 to 5 wt. %, most preferably 4 to 4.95 wt. % of a second polyamide (b) being a polyamide of AB type, and
0.5 to 35 wt. %, preferably of 1 to 35 wt. %, more preferably of 1 to 30 wt. %, even more preferably of 1 to 25 wt. %, even more preferably 1 to 20 wt. %, and most preferably 1 to 19 wt. % of a functional group-modified polyolefin (c),
   wherein wt. % are relative to the total weight of the thermoplastic composition.

The composition of said embodiment may further comprise:
0 to 30 wt. % of at least one other component (d), wherein wt. % is relative to the total weight of the thermoplastic composition.

Alternatively, said composition may further comprise:
0.01 to 10 wt. % of an auxiliary additive, wherein wt. % is relative to the total weight of the thermoplastic composition.

Alternatively, said composition may further comprise:
0.01 to 10 wt. % of an auxiliary additive, and
0.01 to 20 wt. % of an inorganic filler and/or a fibrous reinforcing agent, wherein wt. % are relative to the total weight of the thermoplastic composition.

In a further embodiment, the thermoplastic composition for use in a sliding element comprises:
70 to 95 wt. % of a first polyamide (a) being a polyamide of AA-BB type,
0.5 to 10 wt. %, preferably 1 to 10 wt. %, more preferably 2 to 10 wt. %, even more preferably 2 to 8 wt. %, even more preferably 2 to 6 wt. %, even more preferably 4 to 6 wt. %, even more preferably 4 to 5 wt. %, most preferably 4 to 4.95 wt. % of a second polyamide (b) being a polyamide of AB type, and
0.5 to 25 wt. %, preferably of 1 to 25 wt. %, more preferably of 1 to 20 wt. %, and most preferably 1 to 19 wt. % of a functional group-modified polyolefin (c), wherein wt. % are relative to the total weight of the thermoplastic composition.

The composition of said further embodiment may further comprise:
0 to 20 wt. % of at least one other component (d), wherein wt. % is relative to the total weight of the thermoplastic composition.

Alternatively, said composition may further comprise:
0.01 to 10 wt. % of an auxiliary additive, wherein wt. % is relative to the total weight of the thermoplastic composition.

Alternatively, said composition may further comprise:
0.01 to 5 wt. % of an auxiliary additive, and
0.01 to 15 wt. % of an inorganic filler and/or a fibrous reinforcing agent, wherein wt. % are relative to the total weight of the thermoplastic composition.

In yet another further embodiment, the thermoplastic composition for use in a sliding element comprises:
70 to 90 wt. % of a first polyamide (a) being a polyamide of AA-BB type,
1 to 10 wt. %, preferably 2 to 10 wt. %, more preferably 2 to 8 wt. %, even more preferably 2 to 6 wt. %, even more preferably 4 to 6 wt. %, even more preferably 4 to 5 wt. %, most preferably 4 to 4.95 wt. % of a second polyamide (b) being a polyamide of AB type, and
0.5 to 25 wt. %, preferably 1 to 25 wt. %, more preferably 5 to 25 wt. %, even more preferably 5 to 20 wt. %, and most preferably 5 to 19 wt. % of a functional group-modified polyolefin (c),
   wherein wt. % are relative to the total weight of the thermoplastic composition.

The composition of said further embodiment may further comprise:
0 to 20 wt. % of at least one other component (d), wherein wt. % is relative to the total weight of the thermoplastic composition.

Alternatively, said composition may further comprise:
0.01 to 10 wt. % of an auxiliary additive, wherein wt. % is relative to the total weight of the thermoplastic composition.

Alternatively, said composition may further comprise:
0.01 to 5 wt. % of an auxiliary additive, and
0.01 to 15 wt. % of an inorganic filler and/or a fibrous reinforcing agent, wherein wt. % are relative to the total weight of the thermoplastic composition.

In yet another further embodiment, the thermoplastic composition for use in a sliding element comprises:
70 to 85 wt. % of a first polyamide (a) being a polyamide of AA-BB type,
2 to 10 wt. %, more preferably 2 to 8 wt. %, even more preferably 2 to 6 wt. %, even more preferably 4 to 6 wt. %, even more preferably 4 to 5 wt. %, most preferably 4 to 4.95 wt. % of a second polyamide (b) being a polyamide of AB type, and
0.5 to 25 wt. %, preferably 5 to 25 wt. %, even more preferably 5 to 20 wt. %, even more preferably 8 to 20 wt. %, even more preferably 10 to 20 wt. %, and most preferably 10 to 19 wt. % of a functional group-modified polyolefin (c), wherein wt. % are relative to the total weight of the thermoplastic composition.

The composition of said further embodiment may further comprise:
0 to 15 wt. % of at least one other component (d), wherein wt. % is relative to the total weight of the thermoplastic composition.

Alternatively, said composition may further comprise:
0.01 to 10 wt. % of an auxiliary additive, wherein wt. % is relative to the total weight of the thermoplastic composition.

Alternatively, said composition may further comprise:
0.01 to 5 wt. % of an auxiliary additive, and
0.01 to 10 wt. % of an inorganic filler and/or a fibrous reinforcing agent, wherein wt. % are relative to the total weight of the thermoplastic composition.

With respect to said above embodiments, further embodiments with regard to the selection of the polyamide (a), the polyamide (b), the functional group-modified polyolefin (c), and the at least one other component (d) are as detailed herein above. In particular, in one embodiment, the first polyamide (a) is selected from PA 46, PA 66, PA 46/6, PA 6T/4T, PA 6T/4T/DT/DI, a copolyamide or a mixture thereof and the second polyamide (b) is selected from PA 6, PA 11, PA 12, a copolyamide or a mixture thereof. More preferably, the first polyamide (a) is selected from PA 46, PA66, PA 46/6, PA 6T/4T, PA 6T/4T/DT/DI, a copolyamide or a mixture thereof and the second polyamide (b) comprises PA 6. Even more preferably, the first polyamide (a) is selected from PA 46, PA66, PA 46/6, PA 6T/4T, PA 6T/4T/DT/DI, a copolyamide or a mixture thereof and the second polyamide (b) consists of PA 6. Even more preferably, the first polyamide (a) is selected from PA 46, PA 46/6, PA 6T/4T, PA 6T/4T/DT/DI, a copolyamide or a mixture thereof and the second polyamide (b) consists of PA 6.

It was surprisingly found that a thermoplastic composition of the present invention exhibited very good processability and conferred excellent sliding characteristics combined with advantageous wear resistance and mechanical properties (such as impact resistance, stiffness and ductility) to a moulded part made therefrom.

The production of a moulded part can be performed using standard methods known to the person skilled in the art, such as injection moulding as described in the Examples.

Said properties of processability, sliding, wear resistance, impact resistance, stiffness and ductility were evaluated by the methods as described in the “test methods” section of the Examples.

In particular, it was found that the processability of the thermoplastic composition of the present invention, as evaluated during compounding or injection moulding, was significantly improved compared to that of a corresponding composition not comprising a second polyamide (b) of AB type (that is to say, a composition merely comprising a first polyamide (a) of AA-BB type and a functional group-modified polyolefin (c)).

In other words, the addition of a limited amount of a second polyamide (b) of AB type in a composition comprising a first polyamide (a) of AA-BB type and a functional group-modified polyolefin (c) was found to result in a significantly improved processability.

When the processability of the thermoplastic composition of the invention was evaluated by the torque [%] as measured in the Examples, the torque [%] was found to decrease as the amount of the second polyamide (b) of AB type increased. That is to say, the processability of the thermoplastic composition of the invention increased as the amount of the second polyamide (b) of AB type increased. The torque [%] was about 1% lower, preferably about 2% lower, more preferably about 3% lower, even more preferably about 4% lower, even more preferable about 5% lower, even more preferable about 6% lower, and most preferably about 8% lower compared to that of a corresponding composition not comprising the second polyamide (b) of AB type.

As a result, the degree of degradation in the thermoplastic composition of the invention was shown to be significantly reduced compared to that of a corresponding composition not comprising a second polyamide (b) of AB type.

When the degree of degradation of the thermoplastic composition of the invention was assessed by the viscosity number (ml/g) as measured in the Examples, the viscosity number (ml/g) was found to increase as the amount of the second polyamide (b) of AB type increased. That is to say, the degree of degradation of the thermoplastic composition of the invention decreased as the amount of the second polyamide (b) of AB type increases. The viscosity number (ml/g) of the thermoplastic composition of the present invention was about 1% higher, preferably about 2% higher, more preferably about 3% higher, even more preferably about 5% higher, even more preferably about 6% higher, even more preferably about 8% higher, and most preferably about 10% compared to that of a corresponding composition not comprising the second polyamide (b) of AB type.

As a further result, a moulded part comprising a thermoplastic composition of the invention was found to have a good or even a very good surface appearance.

The sliding characteristics of a moulded part comprising a thermoplastic composition of the invention were assessed by measuring the coefficient of friction (CoF) of said part as described in the Examples. It was found that the coefficient of friction evaluated under lubricated (i.e. oil) conditions and at elevated temperature (i.e. in the range from 60° C. to 150° C.) on a moulded part comprising a thermoplastic composition of the invention was not only significantly reduced compared to that of a moulded part comprising a reference composition, but also generally lower than that of a moulded comprising a corresponding material comprising another friction reduction additive (also commonly referred to as solid lubricant). For example, it was found that the performance of a moulded part comprising a thermoplastic composition of the present invention was better than that of a moulded part comprising a molybdenum sulphide-, a graphite- or a PTFE-containing composition.

A “reference composition” is defined as a composition comprising a first polyamide (a) of AA-BB type, but not comprising a combination of a second polyamide (b) of AB type and a functional group-modified polyolefin (c). In other words, a “reference composition” is defined as a composition of the present invention not comprising the second polyamide (b) of AB type and the functional group-modified polyolefin (c).

In the context of the present invention, for example in the case wherein the coefficient of friction is measured in a chain-on-guide test as described in the “test methods” section of the Examples, an improvement in friction is defined as a reduction in the coefficient of friction of at least about 5%, wherein the % reduction is relative to the coefficient of friction of moulded part comprising a reference composition. Said about 5% reduction is a substantial improvement for applications such as in the chain tensioners.

In the particular case wherein the coefficient of friction was measured in a ball-on-pyramid test as described in the “test methods” section of the Examples, at a sliding speed of 0.01 m/s, the reduction in the coefficient of friction was of at least about 10%, at least about 15%, preferably at least about 20%, at least about 25%, at least about 30%, more preferably at least about 35%, at least about 40%, even more preferably at least about 45%, most preferably at least about 50%, wherein the % reduction is relative to the coefficient of friction of a moulded part comprising a reference composition. At a sliding speed of 0.05 m/s, the reduction in the coefficient of friction was of at least about 20%, preferably at least about 30%, more preferably at least about 40%, even more preferably at least about 50%, even more preferably at least about 55%, most preferably at least about 60%, wherein the % reduction is relative to the coefficient of friction of a moulded part comprising a reference composition. At a sliding speed of 0.1 m/s, the reduction in the coefficient of friction was of at least about 25%, preferably at least about 30%, more preferably at least about 40%, more preferably at least about 45%, even more preferably at least about 50%, even more preferably at least about 60%, most preferably at least about 70%, wherein the % reduction is relative to the coefficient of friction of moulded part comprising a reference composition. Typically, the coefficient of friction of a moulded part comprising a thermoplastic composition of the invention determined at a sliding speed of 0.1 m/s, was in the range of 0.005 to 0.1, preferably 0.005 to 0.09, 0.005 to 0.07, more preferably 0.005 to 0.06, 0.005 to 0.05, and even more preferably 0.005 to 0.04.

It was also surprisingly found that the sliding characteristics of a moulded part comprising a thermoplastic composition of the present invention, as reflected by the measured CoF of said composition in the Examples, were in the same range than the ones of a moulded part comprising a corresponding composition without the second polyamide (b) of AB type. In other words, the addition of the second polyamide (b) of AB type did not impact negatively the sliding performance of the resulting moulded part. As a result, a moulded part comprising a thermoplastic composition of the present invention maintains excellent sliding properties; that is, similar to the ones of a moulded part comprising a corresponding composition without the second polyamide (b) of AB type.

Besides excellent sliding characteristics, it was surprisingly found that a moulded part comprising a thermoplastic composition of the present invention exhibited advantageous wear resistance.

It was also surprisingly found that the wear resistance of a moulded part comprising a thermoplastic composition of the present invention, as reflected by the assessment of the wear resistance of said composition in the Examples, was either similar or improved when compared to that of a moulded part comprising a corresponding composition without the second polyamide (b) of AB type. Furthermore, when compared to a moulded composition comprising a thermoplastic composition of the present invention, it was found that a moulded composition comprising a corresponding thermoplastic composition with the second polyamide (b) of AB type in an amount of above 10 wt. % (wherein wt. % is relative to the total weight of the thermoplastic composition) exhibited decreased wear resistance.

Besides excellent sliding characteristics and advantageous wear resistance, it was surprisingly found that a moulded part comprising a thermoplastic composition of the present invention exhibited advantageous mechanical properties of impact resistance, stiffness and ductility.

It was found that the thermoplastic composition of the invention exhibited advantageous mechanical properties compared to that of a corresponding composition not comprising a second polyamide (b) of AB type.

As shown in the Examples, a moulded part comprising a thermoplastic composition of the invention maintained a good impact resistance or even exhibited significantly improved impact resistance, when compared to a corresponding composition not comprising a second polyamide (b) of AB type.

Also, the stiffness of a moulded part comprising a thermoplastic composition of the invention, as reflected by the measurement of the tensile modulus of said composition in the Examples, was either similar or significantly improved when compared to that of a moulded part comprising a corresponding composition without the second polyamide (b) of AB type. In particular, the stiffness of a moulded part made from a thermoplastic composition of the invention comprising PA 46 was significantly improved when compared to that of a moulded part comprising a corresponding composition without the second polyamide (b) of AB type.

Furthermore, as shown in the Examples, a moulded part comprising a thermoplastic composition of the invention maintained a good yield strength at elevated temperature (e.g. 120° C.) when compared to a corresponding composition not comprising a second polyamide (b) of AB type. However, when compared to a moulded composition comprising a thermoplastic composition of the present invention, it was found that a moulded composition comprising a corresponding thermoplastic composition with the second polyamide (b) of AB type in an amount of above 10 wt. % (wherein wt. % is relative to the total weight of the thermoplastic composition) exhibited significantly decreased yield strength; i.e. a yield strength loss of 10% or more.

Also furthermore, the ductility of a moulded part comprising a thermoplastic composition of the invention, as reflected by the measurement of the elongation break of said composition in the Examples, was either similar or significantly improved when compared to that of a moulded part comprising a corresponding composition without the second polyamide (b) of AB type.

Accordingly, the addition of a limited amount of a second polyamide (b) in a composition comprising a first polyamide (a) of AA-BB type and a functional group-modified polyolefin (c) results in a composition exhibiting significantly improved processability and conferring excellent sliding characteristics combined with advantageous wear resistance and mechanical properties to a moulded part made therefrom.

The above-described advantages are particularly applicable in industrial applications such as plastic elements sliding against each other.

Accordingly, an aspect of the present invention relates to a moulded part for use in a sliding element and comprising the thermoplastic composition of the present invention or any preferred embodiment thereof as described herein above.

A further aspect of the present invention relates to a sliding element comprising the thermoplastic composition of the present invention or any preferred embodiment thereof as described herein above.

In one embodiment, the sliding element is a sliding element for use in a lubricated sliding system.

In another embodiment, the sliding element is a sliding element for use in a chain transmission apparatus, comprising a sliding contact section for engagement in sliding contact with a chain, wherein the sliding contact section is mainly made the thermoplastic composition of the present invention.

The sliding element typically has a main body which is intended for supporting a sliding contact section and optionally reinforcing the sliding contact section and providing stiffness and rigidity to the sliding element as a whole. The main body will generally also have a portion by which the main body can be fixed to a base. The said fixing portion may comprise for example a bushing, by which the main body can be rotatably attached to a metal pin inserted through the bushing, the pin being fixed to a base.

The sliding contact section and the main body may be made of one and the same material, however, since the sliding contact section has low friction characteristics as a main requirement, whereas the main body has to provide mechanical strength, stiffness and rigidity, properties which are difficult to combine without compromising one property for another, the sliding contact section and the main body are suitably made of different materials.

Accordingly, in a further embodiment, the sliding element comprises a main body supporting the sliding contact section, wherein the main body is made of a material different from the thermoplastic composition. For example, the main body is made of a plastic material or a metal (such as aluminium), preferably a plastic material, more preferably a fibre reinforced plastic material. For mechanical properties, it is advantageous to design the sliding element such that the main body consists of a fiber-reinforced thermoplastic material and the surface layer consists of a non-reinforced thermoplastic material.

In case the sliding contact section and main body are made from different materials, the sliding contact section and the main body can be combined into an integral sliding element by known means.

For example, the sliding contact section constitutes a surface layer on the main body. The sliding element can be over-moulded over the main body and being mechanically interlocked with the main body. Suitably, the surface layer has a thickness in the range of 5 μm-5 mm, although the surface layer may also be thicker than 5 mm or be thinner than 5 μm.

If the main body is made from a second plastic material, a part or all of a joint portion between the sliding contact section and the reinforcement main body can be joined by melting, e.g. vibration welding. In another alternative embodiment, the thermoplastic composition for the sliding contact section and the second plastic material are moulded integrally together by a bi-component injection process, also known as 2K moulding or 2-component moulding, so that once they have set they are fixed together. The material which forms the body is injected into the mould first, followed immediately afterwards by the thermoplastic composition forming a coating or surface layer.

Preferably, where the main body is made of a second plastic material the sliding contact section is integrally moulded with the main body.

In an alternative embodiment, which can be used for a chain guide, as well as a chain tensioner, the sliding contact section can be comprised by a sliding blade mechanically interlocked with the main body. Interlocking to the main body may be accomplished, for example, by the sliding blade having ends inserted into grooves formed in opposite ends of the main body. The sliding blade may fully consist of the thermoplastic composition from which the sliding contact section is made, or may comprise, a base part made of a second material, different from the thermoplastic composition, while the sliding contact section constitutes a surface layer on the base part. In case the sliding contact section and base part are made from different materials, the sliding contact section and the base part can be combined into an integral sliding blade by the same methods described above for the sliding contact section and main body.

The base part, if made from a different material, is preferably made of a plastic material, more preferably a fibre reinforced plastic material. Where the base part is made of a second plastic material, the sliding contact section is preferably integrally moulded with the base part.

The sliding element accordingly to the present invention is advantageously sliding with lubricant (in oil). The sliding element is advantageously for use in a sliding system, more particular a timing chain drive system, such as a power train drive system comprising an engine, a transmission differential and a drive shaft system. In particular, the engine is an internal combustion engine comprising a lubricated chain driven system.

In such systems, the sliding element is in sliding contact with the lubricated chain during practical use of the engine. In particular, these sliding elements are chain guides and chain tensioner arms.

The sliding element according to the invention can also be a gear or a part of a bearing.

The invention also relates to the use of the chain guide, respectively the chain tensioner, comprising the surface layer or bearing or comprising the sliding element comprising the surface layer according to the invention in a lubricated sliding system. The lubricated sliding system suitably is a power train drive system comprising an engine, a transmission differential and a drive shaft system.

The invention also relates to a power train drive system comprising an engine, a transmission differential and a drive shaft system, a drive chain and a plastic component comprising a sliding element in contact with the lubricated drive chain. Preferably, the sliding element in the power train drive system is a sliding element according to the invention or any preferred embodiment thereof, as described herein further above.

A further aspect of the invention relates to an engine comprising a first element comprising a section engaged in sliding contact with a second element. The section engaged in sliding contact with a second element is herein referred to as sliding contact section. Herein the first element is a sliding element, wherein at least the sliding contact section is made, or at least mainly so, of the thermoplastic composition according to the invention, or any preferred embodiment thereof as described herein above. Suitably, the first element, i.e. the sliding element is a chain guide, a chain tensioner, a gear or a part of bearing.

Yet, a further aspect of the invention relates to a chain transmission apparatus, comprising a chain and a sliding element comprising a sliding contact section engaged in sliding contact with the chain and wherein the sliding contact section is made of, or at least mainly so, of the thermoplastic composition according to the invention, or any preferred embodiment thereof as described herein above. The sliding element in the chain transmission apparatus suitably is a chain guide or a chain tensioner. The chain transmission apparatus suitably is a chain driven timing system. In a preferred embodiment, the chain transmission apparatus is advantageously a (oil) lubricated sliding system, but it can also be a non-lubricated sliding system.

A reference herein to a patent document or other matter which is given as prior art is not to be taken as an admission that that document or matter was known or that the information it contains was part of the common general knowledge as at the priority date of any of the claims.

The present invention is further illustrated with the following examples and comparative experiments.

### EXAMPLE

### Materials

PA 46 Polyamide 46 (DSM, The Netherlands), VN=205 ml/g, Tm=290° C., NH 2 end-group content=24 meq/kg
PA 66 Polyamide 66 (DSM, The Netherlands), VN=168 ml/g, Tm=260° C., NH₂ end-group content=30 meq/kg
PPA Polyamide 6T/4T/6I (54/24/22 mol/mol/mol) (DSM, The Netherlands), VN=125 ml/g, Tm=322° C., NH₂ end-group content=40 meq/kg
PA 6 Polyamide 6 (DSM, The Netherlands), VN=115 ml/g, Tm=220° C., NH₂ end-group content=54 meq/kg
MAH-EP Exxelor™ VA 1801 (ExxonMobil Chemical): maleic anhydride (MAH)-modified ethylene propylene copolymer (EP), MAH content=0.62 wt. %, MFR (230° C., 2.16 kg load)=2 g/10 min, density=880 kg/m³
Stanyl® HGR2 Polyamide 46+PTFE (DSM, the Netherlands)
Leona™ 1542 Polyamide 66+PTFE (Asahi Kasei, Japan)

### Preparation (Compounding) of Thermoplastic Compositions

Thermoplastic compositions were prepared from PA 46 and various fillers in a Berstorff ZE25/48UTX co-rotating twin screw extruder. The temperature settings of the extruder were such that the melt temperature at the exit of the extruder was typically 330° C. The compositions comprising PA 46 are described in Table 1 and Table 3.

Thermoplastic compositions were prepared from PA 66 and various fillers in a Berstorff ZE25/48UTX co-rotating twin screw extruder. The temperature settings of the extruder were such that the melt temperature at the exit of the extruder was typically 310° C. The compositions comprising PA 66 are listed in Table 1 and Table 4.

Thermoplastic compositions were prepared from PPA and various fillers in a Berstorff ZE25/48UTX co-rotating twin screw extruder. The temperature settings of the extruder were such that the melt temperature at the exit of the extruder was typically 350° C. The compositions comprising PPA are described in Table 1.

### Preparation of Injection Moulded Parts

The PA 46-, PA 66-, PPA-based thermoplastic compositions reported in Table 1 and used for making injection moulded test samples were pre-dried by applying the following conditions: the compositions were heated under vacuum of 0.02 MPa to 105° C. in case of PA 46- and PPA-based compositions and to 80° C. in case of PA 66-based compositions and kept at these temperatures and pressure for 24 hr while a stream of nitrogen was passed. The pre-dried compositions were injection moulded on an injection moulding machine Arburg A150, 40 mm machine using a mould with a cavity providing for a test sample (e.g. strip, bar, plate) used in the characterization tests below. The temperature of the cylinder wall was chosen so that the temperature of the melt is 20° C. above the melting temperature of the polyamide in case of the PA 46- and PA 66-based compositions, and 10° C. above the melting temperature of the polyamide in case of the PPA-based compositions. The temperature of the mould was set at 120° C. in case of PA 46- and PPA-based compositions and at 80° C. in case of PA 66-based compositions. The parts so obtained were cooled and stored under dry conditions at room temperature prior to use for the below characterization tests.

### Test Methods

### Melting Temperature (Tm)

The melting temperature [° C.] of a polyamide was measured by the DSC method according to ISO-11357-1/3, 2011, on pre-dried samples in a N2 atmosphere with heating and cooling rate of 10° C./min. Herein, Tm has been calculated from the peak value of the highest melting peak in the second heating cycle.

### Amino (NH₂) End-Group Content

The amino end-group content in a polyamide [meq/kg] was potentiometrically determined by titration of a methanol solution of the polyamide with 0.03 N hydrochloric acid.

### Melt Flow Rate (MFR)

The Melt Flow Rate of the MAH-modified polyolefin was determined by the method according the ASTM norm D1238 at 230° C. and 2.16 kg load.

### Maleic Anhydride (MAH) Content

Films of a MAH-modified polyolefin were prepared by melt-pressing and FT-IR spectra were recorded on said films using a Perkin Elmer Spectrum One FT-IR spectrometer. Peak height measurements were done on the absorbance spectra. Correction for differences in film thickness was done by normalizing the spectra using a vibration signal of the MAH-modified polyolefin, being the 722 cm⁻¹ peak. For the determination of the peak height at 722 cm⁻¹ (H1), a baseline is drawn between 2000 and 640 cm⁻¹. For the determination of the peak height at 1862 cm⁻¹ (H2), a baseline is drawn between 1910 and 1640 cm⁻¹. The weight percentage of MAH on the sample is calculated with the following equation: MAH (wt. %)=4.2176*(H2/H1)

### Density

The density [kg/m³] of a modified polyolefin was measured by the method according to the ISO norm ISO 1183.

### Processability

The processability of a thermoplastic composition during compounding was evaluated by measuring the torque [%] during their preparation in the ZE 25/48UTX Berstorff extruder running at 300 rpm and at a throughput of 20 kg/h.

The processability of a thermoplastic composition during injection moulding was determined based on the visual evaluation of the surface appearance of the resulting moulded parts.

### Viscosity Number (VN)

The viscosity number [ml/g] of a polyamide or a thermoplastic composition after compounding was determined by the method according to ISO 307 at 25° C. (0.5 wt. % in 96 wt. % sulfuric acid for PPA and PA 66 and 0.5 wt. % in 90% wt. formic acid for PA 6 and PA 46).

### Tensile Modulus

The tensile modulus [MPa] of a moulded test sample was measured in a tensile test according to ISO 527 at 50 mm/min and at 23° C.

### Yield Strength

The tensile modulus [MPa] of a moulded test sample was measured in a tensile test according to ISO 527 at 50 mm/min and at 120° C.

### Elongation at Break

The elongation at break [%] of a moulded test sample was determined in a tensile test according to ISO 527 at 23° C. or at 120° C. and 50 mm/min.

Impact Resistance (i.e. Impact Strength)

The impact strength [kJ/m²] of a moulded test sample was determined in a Charpy notched impact strength test at 23° C. according to ISO 179/1eU and an Izod notched impact strength test at −20° C. according to ISO 180.

### Coefficient of Friction (CoF) Measurement in a Chain-On-Guide Test

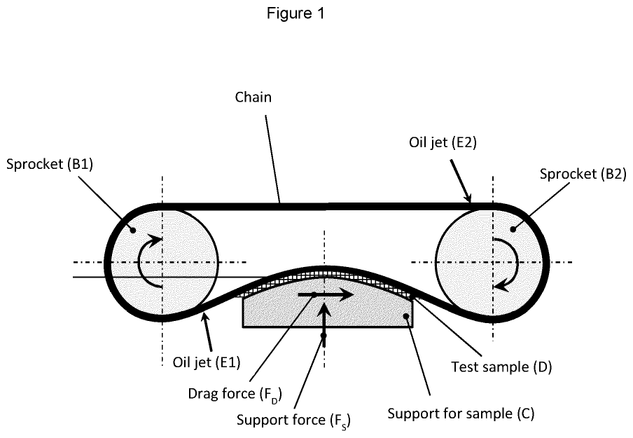

A chain (Schaeffler 16G2, 84 links, surface roughness RA ˜0.1 μm-0.2 μm) was installed between two identical sprockets (B1) and (B2) (Schaeffler, z=24), and pre-stressed to a force of 670 N±10 N on the sprockets as shown in FIG. 1. A moulded strip test sample (D) with dimensions of 30 mm (width)×125 mm (length)×2 mm (thickness) was mounted onto a support (C) having a radius of curvature of 110 mm. The moulded strip test sample (D) and the support (C) were pressed against the chain at a support force (F_{S}) equal to 100 N. The system was installed in a compartment and heated to the test temperature (120° C.) by spraying commercially available engine oil (Castrol Edge 5W30 FST) onto the chain at locations E1 and E2 at a flow rate of 2 rpm and 2 bar. The system was allowed to equilibrate for 1 hour. Next, the support force (F_{S}) was increased to 175 N±5 N and the chain was run over the plastic guide at a constant speed for 1 hour by driving sprocket B1 (1000 rpm sprocket speed, 2.55 m/s chain sliding speed). After this run-in phase, the actual friction measurement was started by stepwise increasing the sprocket speed from 500 rpm to 5000 rpm. At each sprocket speed, the system was first allowed to equilibrate for 5 seconds after which the drag force (F_{D}) and support force (F_{S}) were logged for 5 seconds. The averages over these 5 second periods were used in the CoF calculations. The step increase between two speed levels took 3 seconds. The CoF was determined from the ratio F_{D}/F_{S}, wherein F_{D} is the drag force and F_{S} is the support force.

### Coefficient of Friction (CoF) Measurement in a Ball-On-Pyramid Test

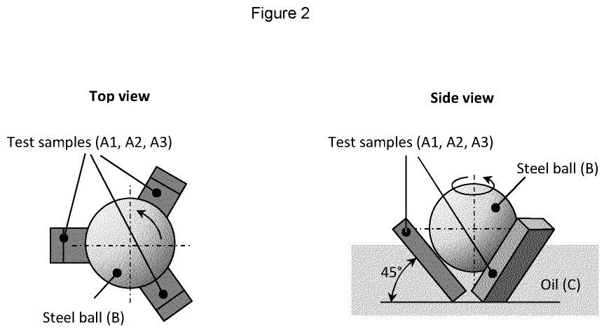

The set-up is commercially available as the Anton-Paar Tribo-cell T-BTP and is mounted in an Anton-Paar MCR 501 rheometer. Three identical moulded test samples A1, A2, and A3 with dimensions of 6 mm (width)×15 mm (length)×2 mm (thickness) were placed under a 45° orientation angle as shown in FIG. 2. The test samples were taken from the grip section of an ISO 527 1A tensile test bar. The surface roughness of the samples before the test was better than RA=0.2 μm. A chromium steel ball (B) (ISO 3290 G20, 12.7 mm diameter, surface roughness RA˜0.03 μm) was placed in the center and was supported by the three plastic samples. The ball-on-plate assembly was placed in an oil bath (C) (Castrol Edge 5W30) such that the contact points between ball and plastic were submerged in oil. After this, the whole assembly was heated to the test temperature (120° C.) and allowed to equilibrate for 30 minutes. The normal load was applied on the ball (1 N) and the system was run for 10 minutes at 10 min⁻¹ (4.7·10⁻³ m/s sliding speed at contacts). Next the velocity sweep was started, where the friction was measured stepwise at different velocity levels from 10⁻⁴ m/s to 1 m/s. At each velocity, the ball was sliding over the plastic surfaces for at least 30 mm and the CoF was reported as the average value over this distance.

### Wear Resistance

The wear resistance of a moulded test sample was determined after the coefficient of friction measurements according to the ball-on-pyramid test by assessing the depth of the mark on the test sample with the deepest/best visible wear mark.

### Examples and Comparative Examples

### Examples I to IX and Comparative Examples a to G

### Examples I, II, Ill (EX I, EX II, EX III)

EX I, EX II and EX III were prepared according to the compositions in Table 1, wherein all compositions comprised PA 46 in combination with PA 6 (4.5 wt. %) and MAH-EP (5 wt. %, 10 wt. % and 19 wt. %).

### Comparative Examples A, B, C (CEX A, CEX B, CEX C)

CEX A and CEX B were prepared according to the compositions in Table 1. CEX C (Stanyl® HGR2) is a commercially available composition comprising PA 46 and PTFE.

### Examples IV, V, VI (EX IV, EX V, EX VI)

EX IV, EX V and EX VI were prepared according to the compositions in Table 1, wherein all compositions comprised PA 66 in combination with PA 6 (4.5 wt. %) and MAH-EP (5 wt. %, 10 wt. % and 19 wt. %).

### Comparative Examples D, E (CEX D, CEX E)

CEX D was prepared according to the compositions in Table 1. CEX E (Leona™ 1542) is a commercially available composition comprising PA 66 and PTFE.

### Examples VII, VIII, IX (EX VII, EX VIII, EX IX)

EX VII, EX VIII and EX IX were prepared according to the compositions in Table 1, wherein all compositions comprised PPA in combination with PA 6 (4.5 wt. %) and MAH-EP (5 wt. %, 10 wt. % and 19 wt. %)

### Comparative Examples F, G (CEX F, CEX G)

CEX F and CEX G were prepared according to the compositions in Table 1.

### Results

Results of the friction tests are indicated in Table 1.

Results of the physical and mechanical tests are indicated in Table 2.

TABLE 1
Friction properties of the thermoplastic compositions

| | EX | EX | EX | CEX | CEX | CEX | EX | EX |
|---|---|---|---|---|---|---|---|---|
| | I | II | III | A | B | C | IV | V |
| | Thermoplastic composition (wt. %) or commercial product | | | | | | | |
| PA 46 | 89 | 84 | 75 | 98.5 | 79.5 | Stanyl ® | — | — |
| PA 66 | — | — | — | — | — | HGR2 | 89 | 84 |
| PPA | — | — | — | — | — | | — | — |
| PA 6 | 4.5 | 4.5 | 4.5 | — | — | | 4.5 | 4.5 |
| MAH-EP | 5 | 10 | 19 | — | 19 | | 5 | 10 |
| Auxiliary | 1.5 | 1.5 | 1.5 | 1.5 | 1.5 | | 1.5 | 1.5 |
| additives | | | | | | | | |
| Ball on | | | | | | | | |
| pyramid test | CoF vs. sliding speed (m/s) | | | | | | | |
| 0.01 m/s | 0.098 | 0.069 | 0.065 | 0.134 | 0.060 | 0.117 | 0.111 | 0.095 |
| 0.05 m/s | 0.073 | 0.051 | 0.050 | 0.144 | 0.052 | 0.128 | 0.105 | 0.082 |
| 0.1 m/s | 0.053 | 0.038 | 0.038 | 0.127 | 0.037 | 0.119 | 0.094 | 0.066 |
| Chain on | | | | | | | | |
| guide test | CoF vs. sprocket speed (rpm) | | | | | | | |
| 1000 rpm | 0.042 | 0.039 | 0.036 | 0.047 | n.d. | 0.043 | 0.043 | 0.039 |
| 1750 rpm | 0.039 | 0.038 | 0.036 | 0.041 | n.d. | 0.039 | 0.039 | 0.038 |

| | EX | CEX | CEX | EX | EX | EX | CEX | CEX |
|---|---|---|---|---|---|---|---|---|
| | VI | D | E | VII | VIII | IX | F | G |
| | Thermoplastic composition (wt. %) or commercial product | | | | | | | |
| PA 46 | — | — | Leona ™ | — | — | — | — | — |
| PA 66 | 75 | 98.5 | 1542 | — | — | — | — | — |
| PPA | — | — | | 89 | 84 | 75 | 98.5 | 93.5 |
| PA 6 | 4.5 | — | | 4.5 | 4.5 | 4.5 | — | — |
| MAH-EP | 19 | — | | 5 | 10 | 19 | — | 5 |
| Auxiliary | 1.5 | 1.5 | | 1.5 | 1.5 | 1.5 | 1.5 | 1.5 |
| additives | | | | | | | | |
| Ball on | | | | | | | | |
| pyramid test | CoF vs. sliding speed (m/s) | | | | | | | |
| 0.01 m/s | 0.071 | 0.132 | 0.114 | 0.089 | 0.068 | 0.039 | 0.118 | 0.085 |
| 0.05 m/s | 0.059 | 0.138 | 0.116 | 0.057 | 0.048 | 0.031 | 0.116 | 0.062 |
| 0.1 m/s | 0.046 | 0.125 | 0.106 | 0.033 | 0.031 | 0.025 | 0.095 | 0.040 |
| Chain on | | | | | | | | |
| guide test | CoF vs. sprocket speed (rpm) | | | | | | | |
| 1000 rpm | 0.038 | 0.046 | 0.043 | 0.034 | 0.033 | 0.033 | n.d. | n.d. |
| 1750 rpm | 0.037 | 0.041 | 0.039 | 0.033 | 0.033 | 0.033 | n.d. | n.d. |

wt. % wt. % is relative to the total weight of the thermoplastic composition
n.d. not determined

The results in Table 1 show that the reference PA 46, PA 66 and PPA compositions (being CEX A, CEX D and CEX F respectively) conferred the highest friction levels to a moulded part. These reference compositions are therefore not suitable for use in a sliding element.

The addition of MAH-EP in an increasing amount from 5 wt. % up to 19 wt. % in said reference compositions, optionally with a supplemental addition of 4.5 wt. % PA 6, resulted in a significant reduction in the friction level of a moulded part.

For example, in the ball-on-pyramid test, the coefficients of friction of EX I, EX II and EX III were from about 25% to about 70% lower relative to the coefficient of friction of CEX A evaluated at the same sliding speed. Similarly, in the ball on pyramid test, the coefficients of friction of EX IV, EX V and EX VI were from about 10% to about 65% lower relative to the coefficient of friction of CEX D evaluated at the same sliding speed. Also, in the ball on pyramid test, the coefficients of friction of EX VII, EX XIII and EX IX were from about 20% to about 75% lower relative to the coefficient of friction of CEX F evaluated at the same sliding speed.

The effect of adding MAH-EP on the friction levels was also demonstrated in a real-life application test (i.e. the chain-on-guide test), wherein a reduction in the coefficient of friction from about 5% to about 25% was observed, wherein the % reduction is relative to the coefficient of friction of a moulded composition comprising a reference composition evaluated at the same sprocket speed.

Additionally, the inventors observed that the presented examples generally exhibited significantly improved friction levels over the moulded parts comprising commercially available compositions containing PTFE (CEX C and CEX E).

It was also observed that levels of friction of comparative examples CEX B and CEX G (comprising MAH-EP but not PA 6) were similar to that of their direct counterparts EX III and EX VII (comprising MAH-EP and PA 6), when compared in the same test and at a same speed level. However, when compared to CEX B and CEX G, EX III and EX VII showed advantageous physical and mechanical properties as indicated in Table 2 below.

TABLE 2
Physical and mechanical properties of the thermoplastic compositions

| | EX | CEX | CEX | EX | CEX | EX | CEX |
|---|---|---|---|---|---|---|---|
| | III | B | C | V | E | VII | G |
| | Thermoplastic composition (wt. %) or commercial product | | | | | | |
| PA 46 | 75 | 79.5 | Stanyl ® | — | Leona ™ | — | — |
| PA 66 | — | — | HGR2 | 84 | 1542 | — | — |
| PPA | — | — | | — | | 89 | 93.5 |
| PA 6 | 4.5 | — | | 4.5 | | 4.5 | — |
| MAH-EP | 19 | 19 | | 10 | | 5 | 5 |
| Auxiliary additives | 1.5 | 1.5 | | 1.5 | | 1.5 | 1.5 |
| Processability Torque (%) | 79 | 84 | n.d. | n.d. | n.d. | 55 | 59 |
| Processability | +++ | ++ | − | +++ | − | ++ | ++ |
| Surface appearance | | | | | | | |
| Viscosity number (ml/g) | 190 | 168 | n.d. | n.d. | n.d. | 130 | 125 |
| Charpy notched impact | 105 | 100 | n.d. | 17 | n.d. | 13 | 13 |
| strength, 23° C. (kJ/m²) | | | | | | | |
| Izod notched impact | 59 | 31 | n.d. | n.d. | n.d. | n.d. | n.d |
| strength, −20° C. (kJ/m²) | | | | | | | |
| Tensile modulus, 23° C. | 1785 | 1726 | n.d. | 2618 | n.d. | 3290 | 3111 |
| (MPa) | | | | | | | |
| Elongation at break, | 74 | 62 | n.d | 12 | n.d. | 3.5 | 3.4 |
| 23° C. (%) | | | | | | | |
| Elongation at break, | 205 | 139 | n.d. | >200 | n.d. | 139 | 59 |
| 120° C. (%) | | | | | | | |

wt. % wt. % is relative to the total weight of the thermoplastic composition
n.d. not determined
(+++) indicates very good surface appearance with no streaks and no defects
(++) indicates good surface appearance with no streaks but with minor defects
(−) indicates poor surface appearance with streaks and defects

The results in Table 2 show that the thermoplastic compositions of the invention comprising a limited amount of PA 6 (i.e. 4.5 wt. %) and different amounts of MAH-EP (EX Ill, EX V, EX VII) had very good processability. This was a significant improvement over the thermoplastic compositions comprising MAH-EP alone (CEX B, CEX G) and, even more significant over the commercially available compositions containing PTFE (CEX C and CEX E).

As a result, the degree of degradation in the thermoplastic compositions of the invention were lower than the ones in the comparative examples (as reflected by the viscosity number in Table 2). In particular, the viscosity number of EX III was about 13% higher than the one of CEX B which is a significant improvement.

The results in Table 2 further show that the thermoplastic compositions of the invention exhibited advantageous mechanical properties compared to that of the compositions of the comparative examples.

For example, when compared with CEX B, the inventors surprisingly found that EX III had significantly improved impact resistance (e.g. about 90% increase in an Izod notched impact strength test at −20° C.), stiffness (e.g. about 4% increase in tensile modulus at 23° C.) and ductility (e.g. about 50% increase in elongation at break at 120° C.).

Furthermore, the inventors found that the thermoplastic compositions of the invention had good wear properties for their application in a sliding element.

To summarize, the data showed that the addition of PA 6 in a limited amount (e.g. 4.5 wt. %) in a thermoplastic composition comprising MAH-EP resulted in improved thermoplastic compositions having very good processability and conferring excellent sliding characteristics combined with advantageous wear resistance and mechanical properties (such as impact resistance, stiffness and ductility). Said advantages are particularly applicable and beneficial in industrial applications such as a sliding element.

### Examples X to XV and Comparative Examples H to I

### Examples X to XV (EX X to EX XV)

EX X to EX XV were prepared according to the compositions in Table 3, wherein all compositions comprised PA 46 in combination with PA 6 (1 wt. %, 2 wt. %, 4.5 wt. %, 6 wt. %, 8 wt. % and 10 wt. %) and MAH-EP (10 wt. %).

### EX XII Corresponds to EX II

### Comparative Example H (CEX H)

CEX H was prepared according to the composition in Table 3, wherein said composition comprised PA 46 in combination with PA 6 (15 wt. %) and MAH-EP (10 wt. %).

### Comparative Example I (CEX I)

CEX I was prepared according to the composition in Table 3.

### Results

Results of friction, physical and mechanical tests are indicated in Table 3.

TABLE 3
Friction, physical and mechanical properties of the thermoplastic compositions

| | EX | EX | EX | EX | EX | EX | CEX | CEX |
|---|---|---|---|---|---|---|---|---|
| | X | XI | XII | XIII | XIV | XV | H | I |
| | Thermoplastic composition (wt. %) | | | | | | | |
| PA 46 | 87.5 | 86.5 | 84 | 82.5 | 80.5 | 78.5 | 73.5 | 88.5 |
| PA 6 | 1 | 2 | 4.5 | 6 | 8 | 10 | 15 | — |
| MAH-EP | 10 | 10 | 10 | 10 | 10 | 10 | 10 | 10 |
| Auxiliary additives | 1.5 | 1.5 | 1.5 | 1.5 | 1.5 | 1.5 | 1.5 | 1.5 |
| Ball on pyramid test | CoF vs. sliding speed (m/s) | | | | | | | |
| 0.01 m/s | 0.068 | n.d. | 0.069 | 0.082 | 0.081 | n.d. | n.d. | 0.078 |
| 0.05 m/s | 0.041 | n.d. | 0.051 | 0.066 | 0.054 | n.d. | n.d. | 0.054 |
| 0.1 m/s | 0.032 | n.d. | 0.038 | 0.051 | 0.039 | n.d. | n.d. | 0.035 |
| Processability Torque (%) | 74 | 72 | 72 | 71 | 67 | 68 | 66 | 74 |
| Viscosity number (ml/g) | 187 | 191 | 195 | 199 | 205 | 208 | 221 | 184 |
| Charpy notched impact | 27 | 26 | 27 | 25 | 24 | 24 | 25 | 26 |
| strength, 23° C. (kJ/m²) | | | | | | | | |
| Tensile modulus, 23° C. | 2475 | 2497 | 2498 | 2483 | 2461 | 2467 | 2479 | 2452 |
| (MPa) | | | | | | | | |
| Yield strength, 120° C. | 35 | 35 | 34 | 33 | 33 | 32 | 30 | 35 |
| (MPa) | | | | | | | | |
| Elongation at break, | 219 | 200 | 208 | 204 | 221 | n.b. | n.b. | 209 |
| 120° C. (%) | | | | | | | | |
| Wear resistance | ++ | ++ | ++ | ++ | ++ | ++ | + | + |

wt. % wt. % is relative to the total weight of the thermoplastic composition
n.d. not determined
n.b. no break
(++) indicates improved wear resistance compared to reference
(+) indicates good wear resistance (reference)
(−) indicates decreased wear resistance compared to reference

The results in Table 3 show that the addition of PA 6 in an increasing amount from 1 wt. % up to 10 wt. % in a composition comprising PA 46 and 10 wt. % MAH-PE, resulted in compositions conferring excellent sliding characteristics to a moulded part made therefrom. In other words, the addition of increasing amounts of PA 6 from 1 wt. % to 10 wt. % did not impact negatively the sliding performance of the resulting moulded parts.

However, when compared to CEX H and CEX I, EX X and EX XV showed advantageous physical and mechanical properties as indicated in Table 3 above.

The results in Table 3 show that the thermoplastic compositions of the invention comprising a limited amount of PA 6 from 1 wt. % to 10 wt. % and 10 wt. % of MAH-EP (EX X to EX XV) had very good processability. This was a significant improvement over the thermoplastic compositions comprising 10 wt. % MAH-EP alone (CEX I).

As a result, the degrees of degradation in EX X to EX XV were lower than the one in CEX I (as reflected by the viscosity number in Table 3). In particular, the viscosity numbers of EX X, EX XI, EX XII, EX XIII, EX XIV, EX XV were about 2%, 4%, 6%, 8%, 11%, 13% higher than the one of CEX I.

The results in Table 3 further show that the thermoplastic compositions of the invention exhibited advantageous mechanical properties compared to that of the compositions of the comparative examples.

For example, when compared with CEX I, the inventors surprisingly found that EX X to EX XV had maintained or improved impact resistance, maintained or improved ductility, increased stiffness (e.g. about 1 to 2% increase in tensile modulus at 23° C.).

Furthermore, when compared with CEX I, the inventors showed that EX X to EX XV maintained a good yield strength at 120° C. However, an amount of PA 6 above 10 wt. % conferred a significant loss in yield strength (i.e. more than 10% loss) to a moulded part (e.g. about 14% loss at 15 wt. % PA6).

Also, when compared with CEX H and CEX I, the inventors surprisingly found that EX X to EX XV had superior wear resistance. That is, EX X to EX XV had improved wear resistance compared to that of CEX I not comprising PA6 and EX X to EX XV had improved wear resistance compared that CEX H comprising 15 wt. % PA 6. An amount of PA 6 above 10 wt. % conferred a significant loss in wear resistance.

Altogether, the data showed that an amount of PA 6 above 10 wt. % negatively impacted the overall performance of the resulting moulded part.

To summarize, the data showed that the addition of PA 6 in a limited amount (e.g. from 1 wt. % to 10 wt. %) in a thermoplastic composition comprising 10 wt. % MAH-EP resulted in improved thermoplastic compositions having very good processability and conferring excellent sliding characteristics combined with advantageous wear resistance and mechanical properties (such as impact resistance, stiffness and ductility) to a moulded part made therefrom. Said advantages are particularly applicable and beneficial in industrial applications such as a sliding element.

### Examples XVI to XVIII and Comparative Examples J and K

### Examples XVI to XVIII (EX XVI to EX XVIII)

EX XVI to EX XVIII were prepared according to the compositions in Table 4, wherein all compositions comprised PA 66 in combination with PA 6 (2 wt. %, 4.5 wt. % and 10 wt. %) and MAH-EP (10 wt. %).

### EX XVII Corresponds to EX V

### Comparative Example J (CEX J)

CEX J was prepared according to the composition in Table 4, wherein said composition comprised PA 66 in combination with PA 6 (15 wt. %) and MAH-EP (10 wt. %).

### Comparative Example K (CEX K)

CEX K was prepared according to the composition in Table 4.

### Results

Results of friction, physical and mechanical tests are indicated in Table 4.

TABLE 4
Friction, physical and mechanical properties of the thermoplastic compositions

| | EX | EX | EX | CEX | CEX |
|---|---|---|---|---|---|
| | XVI | XVII | XVIII | J | K |
| | Thermoplastic composition (wt. %) | | | | |
| PA 66 | 86.5 | 84 | 78.5 | 73.5 | 88.5 |
| PA 6 | 2 | 4.5 | 10 | 15 | — |
| MAH-EP | 10 | 10 | 10 | 10 | 10 |
| Auxiliary additives | 1.5 | 1.5 | 1.5 | 1.5 | 1.5 |
| Ball on pyramid test | CoF vs. sliding speed (m/s) | | | | |
| 0.01 m/s | 0.099 | 0.095 | 0.084 | 0.082 | 0.090 |
| 0.05 m/s | 0.076 | 0.082 | 0.067 | 0.054 | 0.064 |
| 0.1 m/s | 0.059 | 0.066 | 0.050 | 0.039 | 0.045 |
| Processability Torque (%) | 64 | 63 | 61 | 59 | 65 |
| Viscosity number (ml/g) | 183 | 187 | 196 | 209 | 178 |
| Charpy notched impact | 17 | 17 | 16 | 16 | 17 |
| strength, 23° C. (kJ/m²) | | | | | |
| Tensile modulus, 23° C. (MPa) | 2602 | 2552 | 2527 | 2530 | 2633 |
| Yield strength, 120° C. (MPa) | 27 | 26 | 25 | 24 | 28 |
| Elongation at break, 120° C. (%) | n.b. | n.b. | n.b. | n.b. | n.b. |
| Wear resistance | + | + | + | − | + |

wt. % wt. % is relative to the total weight of the thermoplastic composition
n.d. not determined
n.b. no break
(++) indicates improved wear resistance compared to reference
(+) indicates good wear resistance (reference)
(−) indicates decreased wear resistance compared to reference

The results in Table 4 show that the addition of PA 6 in an increasing amount from 2 wt. % up to 10 wt. % in a composition comprising PA 66 and 10 wt. % MAH-PE, resulted in compositions conferring excellent sliding characteristics to a moulded part made therefrom. In other words, the addition of increasing amounts of PA 6 from 2 wt. % to 10 wt. % did not impact negatively the sliding performance of the resulting moulded parts.

However, when compared to CEX J and CEX K, EX XVI and EX XVIII showed advantageous physical and mechanical properties as indicated in Table 4 above.

The results in Table 4 show that the thermoplastic compositions of the invention comprising a limited amount of PA 6 from 2 wt. % to 10 wt. % and 10 wt. 10% of MAH-EP (EX XVI to EX XVIII) had very good processability. This was a significant improvement over the thermoplastic compositions comprising 10 wt. % MAH-EP alone (CEX K).

As a result, the degrees of degradation in EX XVI to EX XVIII were lower than the one in CEX K (as reflected by the viscosity number in Table 3). In particular, the viscosity numbers of EX XVI, EX XVII, EX XVIII were about 2%, 5%, 10% higher than the one of CEX K.

The results in Table 4 further show that the thermoplastic compositions of the invention exhibited advantageous mechanical properties compared to that of the compositions of the comparative examples.

For example, when compared with CEX K, the inventors surprisingly found that EX XVI to EX XVIII had maintained impact resistance, maintained stiffness, maintained or improved ductility.

Furthermore, when compared with CEX K, the inventors showed that EX XVI to EX XVIII maintained a good yield strength at 120° C. However, an amount of PA 6 above 10 wt. % conferred a significant loss in yield strength (i.e. more than 10% loss) to a moulded part (e.g. about 11% loss at 15 wt. % PA6).

Also, when compared with CEX J and CEX K, the inventors surprisingly found that EX XVI to EX XVIII maintained good wear resistance. That is, EX XVI to EX XVIII had a similar wear resistance compared to that of CEX K not comprising PA6. However, an amount of PA 6 about 10 wt. % (e.g. CEX J) conferred a significant loss in wear resistance.

Altogether, the data showed that an amount of PA 6 above 10 wt. % negatively impacted the overall performance of the resulting moulded part.

To summarize, the data showed that the addition of PA 6 in a limited amount (e.g. from 2 wt. % to 10 wt. %) in a thermoplastic composition comprising 10 wt. % MAH-EP resulted in improved thermoplastic compositions having very good processability and conferring excellent sliding characteristics combined with advantageous wear resistance and mechanical properties (such as impact resistance, stiffness and ductility) to a moulded part made therefrom. Said advantages are particularly applicable and beneficial in industrial applications such as a sliding element.

1. A thermoplastic composition for use in a sliding element comprising:
60 to 95 wt. % of a first polyamide (a) being a polyamide of AA-BB type,
0.5 to 10 wt. % of a second polyamide (b) being a polyamide of AB type, and
0.5 to 35 wt. % of a functional group-modified polyolefin (c),
wherein wt. % are relative to the total weight of the thermoplastic composition.

2. A thermoplastic composition for use in a sliding element comprising:
70 to 85 wt. % of a first polyamide (a) being a polyamide of AA-BB type,
0.5 to 10 wt. % of a second polyamide (b) being a polyamide of AB type, and
0.5 to 25 wt. % of a functional group-modified polyolefin (c),
wherein wt. % are relative to the total weight of the thermoplastic composition.

3. The thermoplastic composition according to claim 1, wherein the composition comprises 1 to 10 wt. %, preferably 2 to 10 wt. % of the second polyamide (b).

4. The thermoplastic composition according to claim 1, wherein the composition comprises 2 to 8 wt. %, preferably 2 to 6 wt. % of the second polyamide (b).

5. The thermoplastic composition according to claim 1, wherein the composition comprises 4 to 8 wt. %, preferably 4 to 6 wt. % of the second polyamide (b).

6. The thermoplastic composition according to claim 1, wherein the composition comprises less than 5 wt. % of the second polyamide (b).

7. The thermoplastic composition according to claim 1, wherein the composition comprises 1 to 25 wt. %, preferably 1 to 20 wt. %, more preferably 1 to 19 wt. % of the functional group-modified polyolefin (c).

8. The thermoplastic composition according to claim 2, wherein the composition comprises 5 to 25 wt. %, preferably 8 to 20 wt. %, more preferably 10 to 20 wt. %, even more preferably 10 to 19 wt. % of the functional group-modified polyolefin (c).

9. The thermoplastic composition according to claim 1, wherein the first polyamide (a) has a melting temperature Tm-1 and the second polyamide (b) has a melting temperature Tm-2, wherein Tm-2 is at least 30° C. lower than Tm-1, preferably at least 50° C. lower than Tm-1.

10. The thermoplastic composition according to claim 1, wherein the first polyamide (a) is selected from PA66, PA46, PA410, PA412, PAST, PA6T, PA6T, PA6T/6I, PA6T/66, PA6T/6, PA 6T/4T, PA6/66, PA66/6T/6I, PA6T/DT-copolyamide, PAST, PA9T/2-MOMDT-copolyamide, PA 10T, PA 10T/106, PA 10T/6T, PA46/6, a copolyamide or a mixture thereof and the second polyamide (b) is selected from PA 6, PA 7, PA 8, PA 9, PA 10, PA 11, PA 12, a copolyamide or a mixture thereof.

11. The thermoplastic composition according to claim 1, wherein the first polyamide (a) is selected from PA 46, PA66, PA 46/6, PA 6T/4T, PA 6T/4T/DT/DI, a copolyamide or a mixture thereof and the second polyamide (b) comprises PA 6.

12. The thermoplastic composition according to claim 1, wherein the first polyamide (a) is selected from PA 46, PA 46/6, PA 6T/4T, PA 6T/4T/DT/DI, a copolyamide or a mixture thereof and the second polyamide (b) consists of PA 6.

13. The thermoplastic composition according to claim 1, wherein the functional group-modified polyolefin (c) is selected from a dicarboxylic acid anhydride-modified polyolefin, an epoxy-modified polyolefin or a mixture thereof, wherein the modified polyolefin has a melt flow rate in the range of 0.5 to 25 g/10 min, as measured according the ASTM norm D1238 (at 230° C., 2.16 kg load).

14. The thermoplastic composition according to claim 1, wherein the composition further comprises 0.01 to 5 wt. % of an auxiliary additive. A sliding element comprising the thermoplastic composition, wherein the sliding element is for use in a lubricated sliding system.

15. A sliding element comprising the thermoplastic composition according to claim 1, wherein the sliding element is for use in a lubricated sliding system.
